(19) United States
(12) Patent Application Publication
(10) Pub. No.: US 2020/0369542 A1
(43) Pub. Date: Nov. 26, 2020

(54) WATER TREATMENT SYSTEM USING OZONE

(71) Applicants: CLEAN TECHNOLOGIES, INC., Pasadena, CA (US); ECLEAN TECHNOLOGIES, LLC., La Canada, CA (US)

(72) Inventors: Alejandro Islas, San Gabriel, CA (US); William Lance Burrows, Big Bear Lake, CA (US)

(21) Appl. No.: 16/763,947

(22) PCT Filed: Nov. 13, 2018
(86) PCT No.: PCT/US2018/060854

§ 371 Date: May 13, 2020

Related U.S. Application Data
(60) Provisional application No. 62/585,376, filed on Nov. 13, 2017.

(51) Int. Cl. C02F 1/78; C02F 1/00

(52) U.S. Cl. CPC C02F 1/78; C02F 1/002; C02F 2201/003; C02F 2201/782; C02F 2303/04; C02F 2201/784; C02F 2301/028

(57) ABSTRACT

A water treatment system includes a container for holding water and a water treatment device secured at an upper portion of the container. The water treating device is configured to filter and disinfect water using ozone. The water treatment device includes a filter element and an ozone distributor wrapped about the filter element in a tortuous configuration.

### PRIORITY CLAIM

This application claims priority to and the benefit of U.S. provisional patent application No. 62/585,376 filed in the United States Patent Office on Nov. 13, 2017, the entire content of which is incorporated herein by reference as if fully set forth below in its entirety and for all applicable purposes.

### BACKGROUND

Ozone contains three atoms of oxygen (O₃) that is different than the two atoms oxygen (O₂) in breathable air. Ozone may also be known as “activated oxygen.” The oxidizing properties of ozone can reduce or eliminate taste and odor problems. Furthermore, ozone is a powerful sterilant that can be used as an effective disinfectant. In some applications, ozone can effectively kill bacteria, viruses, microorganisms, and many other pathogens. Ozone is commonly used to treat and disinfect water.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

One aspect of the present disclosure provides a water treatment system using ozone. The water treatment system includes a container for holding water and a water treatment device secured at an upper portion of the container. The water treating device is configured to filter and disinfect water using ozone. The water treatment device includes a filter element and an ozone distributor wrapped about the filter element.

Another aspect of the present disclosure provides a method of treating water using ozone. The method fills water into a container through a water treatment device secured to an upper portion of the container. The water is filtered and disinfected using the water treatment device. The water treatment device includes a filter element and an ozone distributor wrapped about the filter element.

Another aspect of the present disclosure provides a water treatment device using ozone. The water treatment device includes a filter element for filtering water and an ozone distributor wrapped about the filter element in a tortuous configuration. The ozone distributor is configured to supply ozone to disinfect the filtered water.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating a water treatment system using ozone according to one embodiment.

FIG. 2 is a diagram illustrating an ozone supply according to one embodiment.

FIG. 3 is a picture illustrating an example of the water treatment system of FIG. 1 according to one embodiment.

FIGS. 4 and 5 are pictures illustrating an example of a water treatment device according to one embodiment.

### DETAILED DESCRIPTION

Referring now to the drawings, embodiments of systems and methods of a water treatment system using ozone as a sterilant or disinfectant are disclosed in the present disclosure. The water treatment system is portable with all the working components being self-contained in an easy to carry unit, for example, personal and family size containers or water buckets.

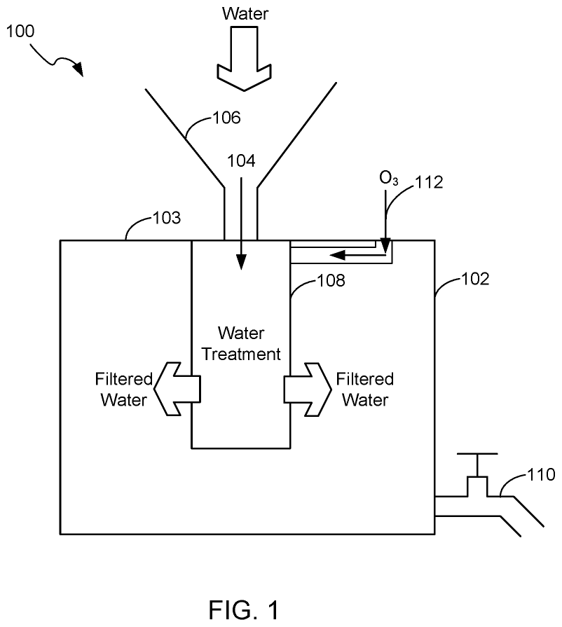

FIG. 1 is a diagram illustrating a water treatment system 100 using ozone according to one embodiment. The water treatment system 100 includes a container 102 for holding water or any desired fluid. Water can be introduced into the container 102 via an inlet 104. In some examples, a funnel 106 or the like may be connected to the inlet 104 for guiding and directing water into the container 102. The funnel 106 is optional and may be omitted in some embodiments. Water entering the container 102 is treated by a water treatment device 108 that is in fluid communication with the inlet 104 that may be located at a top or upper portion of the container 102. For example, the water treatment device may be attached to a lid 103, top, or cover of the container. The water treatment device 108 is configured to filter and disinfect the water, for example, using ozone as a disinfectant. However, this disclosure is not limited to using ozone as a disinfectant. The treated and disinfected water is stored in the container 102 for later use. In some embodiments, an optional spigot 110 or the like may be fitted near the bottom portion of the container 102 to allow the filtered and disinfected water to be discharged. In some embodiments, the water treatment device 108 may receive a supply of ozone (e.g., O₃) or ozone-mixed air 112 from an ozone supply. Any suitable ozone source may be used to supply the ozone.

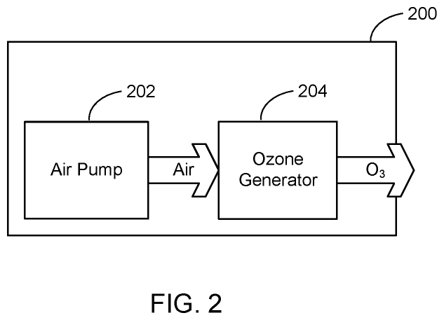

FIG. 2 is a diagram illustrating an ozone supply 200 according to one embodiment. The ozone supply 200 includes an air pump 202 and an ozone generator 204 for generating ozone (e.g., O₃). In operation, the air pump 202 generates an air stream that is mixed with ozone generated by the ozone generator 204. The air stream may have a pressure greater than atmospheric pressure or any desired pressure. The ozone-mixed air stream or ozone may be supplied to the water treatment device 108 to disinfect the filtered water. For example, the ozone generator 204 may be connected to the water treatment device 108 by a hose, conduit, or tubing that carries the ozone-mixed air stream. In some embodiments, the tubing may be a flexible hose made of any suitable material.

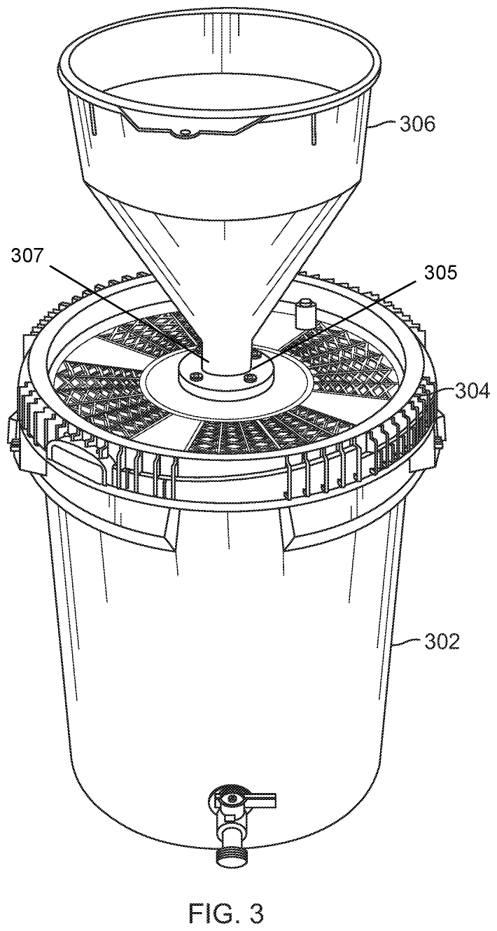

FIG. 3 is a diagram illustrating an example of the water treatment system 100 according to one embodiment. In this example, the water treatment system includes a water bucket 302, a removable lid 304, and a funnel 306 connected to the lid 304. The lid 304 may have an opening 305 that is sized to receive a narrow part 307 of the funnel 306. A water treatment device similar to the water treatment device 108 (not shown in FIG. 3) is fitted inside the bucket 302 and below the lid 304 for filtering and disinfecting water using ozone.

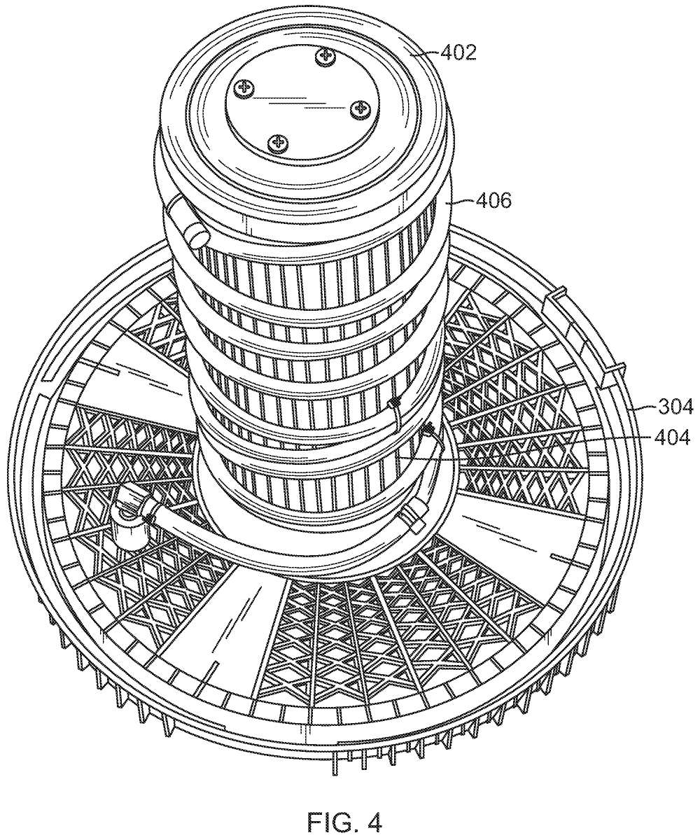

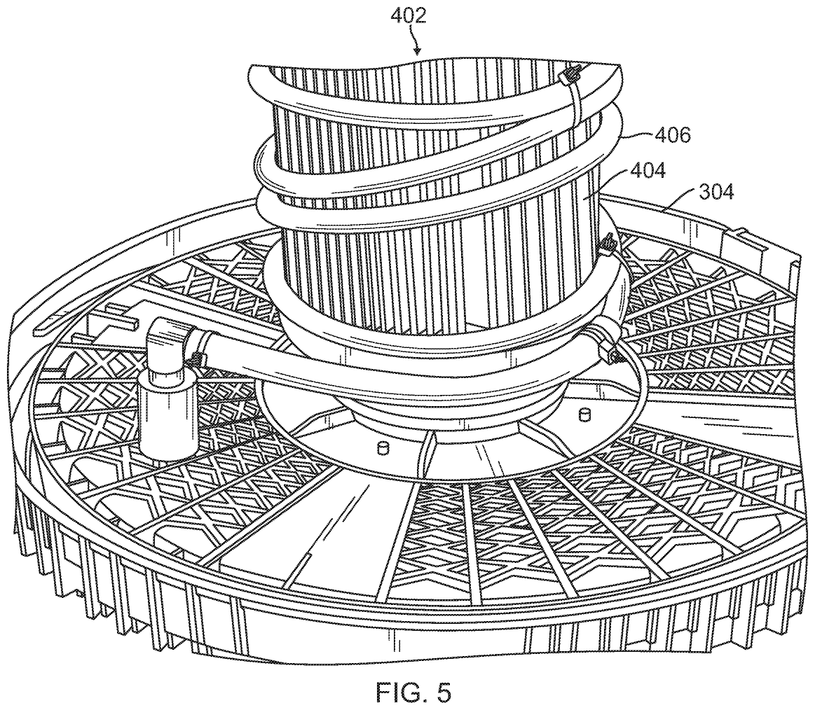

FIGS. 4 and 5 are drawings illustrating an example of a water treatment device 402 according to one embodiment. FIGS. 4 and 5 illustrate the lid 304 of FIG. 3 in an upside-down position to show the water treatment device 402 in a perspective view. The water treatment device 402 may be the same as the water treatment device 108 of FIG. 1. During operation, the lid 304 is installed onto the bucket 302 with the water treatment device 402 located inside the bucket 302. The water treatment device 402 includes a filtering element 404 that is configured to filter sediment, undesirable chemicals, biological contaminants, and/or suspended solids from the water that passes through the filtering element 404. In one embodiment, the filtering element 404 may be a pleated sediment filter or the like. The water treatment device 402 further includes an ozone distributor 406. In one embodiment, the ozone distributor 406 may be a highly porous tube that wraps around the filtering element 404 in a length direction. For example, the ozone distributor 406 (e.g., a highly porous tube) may be arranged in a helical or spiral shape wound around the filtering element 404. In operation, the ozone distributor 406 (e.g., a porous tube) receives a supply of ozone or ozone-mixed air from, for example, the ozone supply 200 via a pneumatically sealed hose or tube of any desired length and/or shape. The ozone distributor 406 is designed and shaped to diffuse an effective amount of ozone to disinfect the water filtered by the filter element 404. In some examples, the ozone distributor 406 can diffuse a large amount of ozone-mixed air bubbles into the filtered water in the water bucket 302 to achieve effective and efficient disinfection of the water using ozone. In one embodiment, the porous tube 406 is configured to provide a large porous surface to volume ratio such that a large amount of ozone-mixed air can be diffused into the water at a very high rate.

In some embodiments, the porous tube 406 when extended is substantially longer than the length and/or width of the water treatment device 402 or filter element 404. In this particular example, the porous tube 406 is coiled or wound around a substantial portion of the filter element 404. In other examples, the porous tube 406 may have other tortuous configurations like a wound shape, coiled shape, helical shape, bend shape, circular shape, rolled shape, spiral shape, and the like. By increasing the length of the porous tube 406 that can be wrapped around the filter element 404, a ratio of the surface area of the porous tube 406 to the volume of the filter element 404 can be increased. The porous tube 406 wraps around an exterior boundary of the filter element 404 two or more times. In some examples, the porous tube 406 wraps around the exterior boundary of the filter element 404 ten or more time. A majority of the porous tube 406 is proximate an exterior surface of the filter element 404. The configuration of the porous tube 406 and filter element 404 allow water to be filtered and ozonated concurrently or simultaneously.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

What is claimed is:

1. A water treatment system using ozone, comprising:
a container for holding water; and
a water treatment device secured at an upper portion of the container and configured to filter and disinfect water using ozone, wherein the water treatment device comprises:
a filter element; and
an ozone distributor wrapped about the filter element.

2. The water treatment system of claim 1, further comprising:
a spigot connected to a lower portion of the container and configured to discharge filtered and ozonated water stored in the container.

3. The water treatment system of claim 1, further comprising:
a funnel connected to the upper portion of the container for guiding water into the water treatment device.

4. The water treatment system of claim 1, further comprising:
an ozone supply configured to provide ozone to the ozone distributor.

5. The water treatment system of claim 1, wherein the ozone distributor comprises a porous tube set in a tortuous configuration around the filter element.

6. The water treatment system of claim 5, wherein the tortuous configuration comprises at least one of:
a coiled shape;
a helical shape;
a spiral shape;
a circular shape; or
a wound shape.

7. The water treatment system of claim 5, wherein the porous tube when extended is substantially longer than the water treatment device in a length direction.

8. The water treatment system of claim 5, wherein the porous tube wraps around an exterior boundary of the filter element two or more times.

9. The water treatment system of claim 8, wherein a majority of the porous tube is proximate an exterior surface of the filter element.

10. The water treatment system of claim 1, wherein the filter element comprises a pleated sediment filter.

11. A method of treating water using ozone, comprising:
filling water into a container through a water treatment device secured to an upper portion of the container; and
filtering and disinfecting the water using the water treatment device, wherein the water treatment device comprises:
a filter element; and
an ozone distributor wrapped about the filter element.

12. The method of claim 11, wherein the ozone distributor comprises a porous tube set in a tortuous configuration around the filter element.

13. The method of claim 12, wherein the tortuous configuration comprises at least one of:
a coiled shape;
a helical shape;
a spiral shape;
a circular shape; or
a wound shape.

14. The method of claim 12, wherein the porous tube when extended is substantially longer than the water treatment device in a length direction.

15. The method of claim 12, wherein the porous tube wraps around an exterior boundary of the filter element two or more times.

16. The method of claim 15, wherein a majority of the porous tube is proximate an exterior surface of the filter element.

17. The method of claim 11, wherein the filter element comprises a pleated sediment filter.

18. A water treatment device using ozone, comprising:
a filter element for filtering water; and
an ozone distributor wrapped about the filter element in a tortuous configuration, the ozone distributor configured to supply ozone to disinfect the filtered water.

19. The water treatment device of claim 18, wherein the tortuous configuration comprises at least one of:
a coiled shape;
a helical shape;
a spiral shape;
a circular shape; or
a wound shape.

20. The water treatment device of claim 18, wherein the ozone distributor comprises a porous tube set in the tortuous configuration around the filter element.

21. The water treatment device of claim 20, wherein the porous tube wraps around an exterior boundary of the filter element two or more times.

22. The water treatment device of claim 21, wherein a majority of the porous tube is proximate an exterior surface of the filter element.
